(19) United States
(12) Patent Application Publication
(10) Pub. No.: US 2018/0157817 A1
(43) Pub. Date: Jun. 7, 2018

(54) UNLOCKING METHOD AND APPARATUS, AND STORAGE MEDIUM

(71) Applicant: Beijing Xiaomi Mobile Software Co., Ltd., Beijing (CN)

(72) Inventors: YI GAO, Beijing (CN); Hongqiang WANG, Beijing (CN); Hai LONG, Beijing (CN)

(73) Assignee: Beijing Xiaomi Mobile Software Co., Ltd.

(21) Appl. No.: 15/371,715

(22) Filed: Dec. 7, 2016

(51) Int. Cl. G06F 21/35

(52) U.S. Cl. CPC G06F 21/35

(57) ABSTRACT

An unlocking method includes detecting an input of unlocking information, and comparing the detected unlocking information with preset reference unlocking information. The method also includes acquiring state information of a user sent by a target wearable device worn by the user, when the detected unlocking information matches the preset reference unlocking information. The method further includes performing unlocking when the state information of the user does not satisfy a preset state condition, and maintaining a screen-locked state when the state information of the user satisfies the preset state condition.

### CROSS-REFERENCE TO RELATED APPLICATIONS

This application is based on and claims the priority of the Chinese patent application No. 201610282789.3, filed on Apr. 29, 2016, which is incorporated herein by reference in its entirety.

### TECHNICAL FIELD

The present disclosure is related to the field of computer technology, and more particularly to an unlocking method and apparatus, and a storage medium.

### BACKGROUND

With the development of computer and communications technologies, mobile terminals such as handsets and tablet computers have been widely used and have become important tools in people's daily life and work. Typically, mobile terminals are provided with a screen-locking function.

A user may lock a screen of a mobile terminal via a screen-locking key. When the mobile terminal is in a screen-locked state, the user cannot operate the mobile terminal using the screen. When the user needs to use the mobile terminal, the user may first unlock the screen and then use the mobile terminal.

In the process of implementing the present disclosure, the inventor(s) found at least the following problem in the prior art: without a user's knowledge (for example, when the user is asleep), others may unlock the user's mobile terminal and acquire information stored therein, or may operate the user's mobile terminal, resulting in poor information security for the user.

### SUMMARY

According to a first aspect of the present disclosure, there is provided an unlocking method. The method includes detecting an input of unlocking information, and comparing the detected unlocking information with preset reference unlocking information. The method also includes acquiring state information of a user sent by a target wearable device worn by the user, when the detected unlocking information matches the preset reference unlocking information. The method further includes performing unlocking when the state information of the user does not satisfy a preset state condition, and maintaining a screen-locked state when the state information of the user satisfies the preset state condition.

According to a second aspect of the present disclosure, there is provided an unlocking apparatus. The unlocking apparatus includes a processor and a memory configured to store instructions executable by the processor. The processor is configured to detect an input of unlocking information, and compare the detected unlocking information with preset reference unlocking information. The processor is also configured to, when the detected unlocking information matches the preset reference unlocking information, acquire state information of a user sent by a target wearable device worn by the user. The processor is further configured to perform unlocking when the state information of the user does not satisfy a preset state condition, and maintain a screen-locked state when the state information of the user satisfies the preset state condition.

According to a third aspect of the present disclosure, there is provided a non-transitory computer-readable storage medium having instructions stored therein that, when executed by a processor of a mobile terminal, cause the mobile terminal to perform an unlocking method. The method includes detecting an input of unlocking information. The method also includes comparing the detected unlocking information with preset reference unlocking information. The method also includes acquiring state information of a user sent by a target wearable device worn by the user when the detected unlocking information matches the preset reference unlocking information. The method further includes performing unlocking when the state information of the user does not satisfy a preset state condition, and maintaining a screen-locked state when the state information of the user satisfies the preset state condition.

It should be understood that both the foregoing general description and the following detailed description are only exemplary and explanatory and are not restrictive of the disclosure.

### BRIEF DESCRIPTION OF THE DRAWINGS

In order to illustrate the technical solutions provided by the embodiments of the present disclosure, a brief introduction is given hereinafter to the accompany drawings referred to in the detailed description of the embodiments. The drawings referred to in the descriptions below are merely for illustrating some embodiments of the present disclosure. Other drawings may be derived by those skilled in the art according to these exemplary drawings without any creative effort.

FIG. 1 is a flowchart showing an unlocking method according to an embodiment of the disclosure.

FIG. 2 is a schematic diagram of a system according to an embodiment of the disclosure.

FIG. 3 is a schematic diagram of an interface display according to an embodiment of the disclosure.

FIG. 4 is a schematic diagram of an interface display according to another embodiment of the disclosure.

FIG. 5 is a schematic structural diagram of an unlocking apparatus according to an embodiment of the disclosure.

FIG. 6 is a schematic structural diagram of an unlocking apparatus according to another embodiment of the disclosure.

FIG. 7 is a schematic structural diagram of an unlocking apparatus according to another embodiment of the disclosure.

FIG. 8 is a schematic structural diagram of an unlocking apparatus according to another embodiment of the disclosure.

FIG. 9 is a schematic structural diagram of an unlocking apparatus according to another embodiment of the disclosure.

FIG. 10 is a schematic structural diagram of an unlocking apparatus according to another embodiment of the disclosure.

FIG. 11 is a schematic structural diagram of a terminal according to an embodiment of the disclosure.

### DETAILED DESCRIPTION

To illustrate the objects, technical solutions, and advantages of the present disclosure, implementations of the present disclosure will be described below in further detail in conjunction with the drawings.

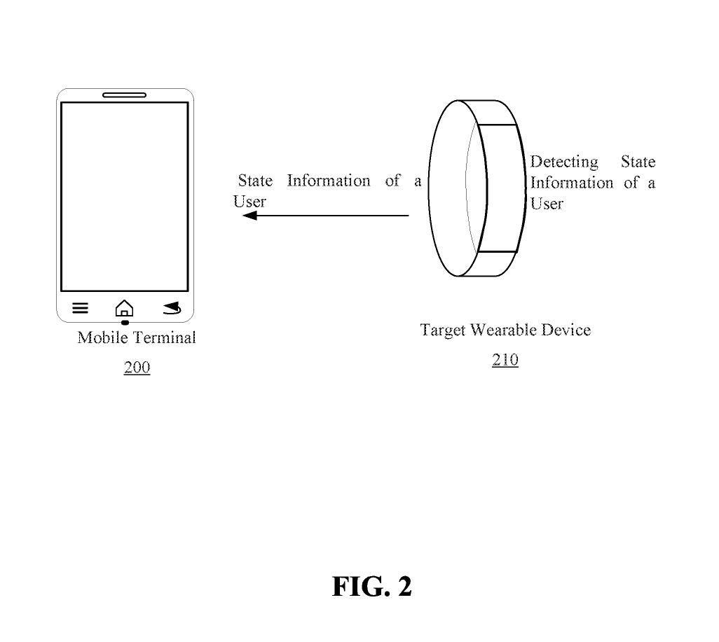

An embodiment of the present disclosure provides an unlocking method performed by a terminal. The terminal may be a mobile terminal such as a handset or a tablet computer. The mobile terminal includes a detecting unit configured to detect an input of unlocking information. The detecting unit may be a fingerprint signal detecting unit, a touch signal detecting unit, or any other detecting unit. The mobile terminal includes a wireless communication module configured to establish a connection with a target wearable device. The mobile terminal includes a transceiver configured to receive state information of a user sent by the target wearable device. The mobile terminal includes a processor configured to determine whether the detected unlocking information matches preset reference unlocking information and whether the state information of the user satisfies a preset state condition so as to perform unlocking or maintain a screen-locked state according to a result of the determination. The mobile terminal further includes a memory configured to store data received or generated in the above process and codes for executing the unlocking method. The codes may be stored in a system program, or may be stored as an independent application program. In some embodiments, the mobile terminal further includes components such as a sensor and a power supply. FIG. 2 is a schematic diagram of a system according to an embodiment of the present disclosure, which includes a mobile terminal 200 and a target wearable device 210.

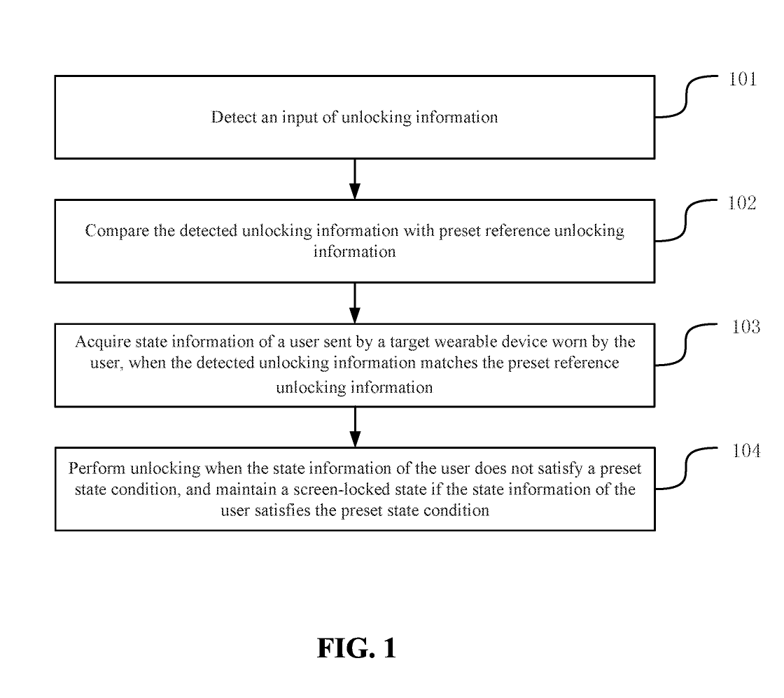

As shown in FIG. 1, the disclosed method includes steps 101-104.

In step 101, an input of unlocking information is detected.

In some embodiments, the mobile terminal 200 is provided with a screen-locking function. Under a screen-locked state, a user cannot operate a screen of the mobile terminal 200. When a user wishes to use the mobile terminal 200, the user needs to unlock the mobile terminal 200. There are various methods for unlocking the mobile terminal 200, such as fingerprint unlocking, password unlocking, and pattern unlocking. Accordingly, when unlocking the mobile terminal 200, the user inputs unlocking information, such as fingerprint information, password information, or pattern information. Thus, the mobile terminal 200 detects the input of unlocking information.

Taking the fingerprint unlocking as an example, the mobile terminal 200 may be provided with a fingerprint detecting component, such as a fingerprint sensor. The fingerprint sensor may be an optical fingerprint sensor, a semiconductor capacitive sensor, a semiconductor thermo-sensitive sensor, a semiconductor pressure-sensitive sensor, an ultrasonic sensor or a radio-frequency (RF) sensor or the like, which is not be limited in the present disclosure. When the user wishes to unlock the mobile terminal 200, the user touches a corresponding position of the fingerprint detecting component with a finger. The fingerprint detecting component may detect fingerprint information of the user.

Referring to FIG. 1, in Step 102, the detected unlocking information is compared with preset reference unlocking information.

In some embodiments, the mobile terminal 200 stores reference unlocking information in advance. The reference unlocking information may be reference fingerprint information, unlocking pattern information set by a user, or an unlocking password. When detecting the input of the unlocking information, the mobile terminal 200 compares the detected unlocking information with the reference unlocking information and determines whether they match. When the mobile terminal 200 determines that the detected unlocking information does not match the preset reference unlocking information, no subsequent process is performed. When the mobile terminal 200 determines that the detected unlocking information matches the preset reference unlocking information, Step 103 is performed.

Referring to FIG. 1, in Step 103, state information of a user sent by the target wearable device 210 worn by the user is acquired, when the detected unlocking information matches the preset reference unlocking information.

In some embodiments, an owner (also referred to as a target user or the user) of the mobile terminal 200 may wear the target wearable device 210. The target wearable device 210 detects state information of the target user. The target wearable device 210 may be any wearable device known in the art, such as a smart band, a smart watch, or smart glasses. The target wearable device 210 is provided with a wireless communication module, such as a Bluetooth module or a WiFi module, to establish a connection with the mobile terminal 200, as shown in FIG. 2. When the target wearable device 210 is provided with a Bluetooth module, the target wearable device 210 sends the detected state information of the target user directly to the mobile terminal 200 through the Bluetooth module. When the target wearable device 210 is provided with a WiFi module, the target wearable device 210 sends the detected state information of the target user to a server. The server may send the detected state information of the target user to the mobile terminal 200. In some embodiments, the server sends the received state information of the target user to the mobile terminal 200 in the form of a push message. In some embodiments, the server sends the state information of the target user to the mobile terminal 200 after receiving a state information request sent by the mobile terminal 200.

The target wearable device 210 may also be provided with a sensor for detecting state information of a user (e.g., the target user), such as an acceleration sensor, a gravity sensor, or a heart rate sensor. The state information may indicate at least one of a sleep state, a running state, a walking state, and a normal state (e.g., a state in which the user sits up or lies down). For example, a smart band and a smart watch may identify the sleep state, walking state, running state, and the like through a gravity sensor, a heart bit sensor, etc. Smart glasses may detect whether the eyes of the user are in a closed state through a built-in photographing component, and thus may determine whether the user is in a sleep state. The target wearable device 210 sends the detected state information of the target user to the mobile terminal 200. In some embodiments, after detecting the input of unlocking information, the mobile terminal 200 acquires the state information of the target user sent by the target wearable device 210 for subsequent processing. There are various trigger conditions for sending the state information of the target user by the target wearable device 210 to the mobile terminal 200. Two exemplary approaches are described as follows.

Approach I: the mobile terminal 200 sends a state information request to the target wearable device 210 worn by the target user to cause the target wearable device 210 to detect current state information of the target user. The mobile terminal 200 receives the current state information of the target user sent by the target wearable device 210.

In some embodiments, the mobile terminal 200 sends the state information request to the target wearable device 210 after detecting the unlocking information input by the target user. The target wearable device 210 detects the current state information of the target user after receiving the state information request. The target wearable device 210 then sends the detected current state information of the target user to the mobile terminal 200. Accordingly, the mobile terminal 200 receives the state information of the target user sent by the target wearable device 210.

Approach II: the mobile terminal 200 receives the state information of the target user sent by the target wearable device 210 worn by the target user, and stores the received state information of the target user. The mobile terminal 200 acquires the stored state information of the target user after detecting the input of the unlocking information.

In some embodiments, the target wearable device 210 detects the state information of the target user at a preset detection cycle (e.g., performs detection when every preset time period passes). The target wearable device 210 sends the detected state information to the mobile terminal 200. Alternatively, the target wearable device 210 sends, after detecting that the state information of the target user changes, the changed state information of the target user to the mobile terminal 200. The mobile terminal 200 receives the state information (including any changed state information) of the target user sent by the target wearable device 210 and stores the received state information. When detecting the unlocking information, the mobile terminal 200 acquires locally stored state information that is received most recently.

Referring to FIG. 1, in Step 104, unlocking is performed when the state information of the user does not satisfy a preset state condition, and a screen-locked state is maintained when the state information of the user satisfies the preset state condition.

In some embodiments, the mobile terminal 200 determines whether the acquired state information of the target user satisfies the preset state condition. When the mobile terminal 200 determines that the state information of the user does not satisfy the preset state condition, the mobile terminal 200 performs unlocking. For example, the mobile terminal 200 performs unlocking when it determines that the state information of the target user indicates that the target user is not in a sleep state. The mobile terminal 200 maintains a screen-locked state when it determines that the state information of the user satisfies the preset state condition. The preset state condition may require the state information to indicate a sleep state. Accordingly, when the target user is in a sleep state and the mobile terminal 200 determines that the detected unlocking information matches the preset reference unlocking information, which implies that another user is attempting to unlock the mobile terminal 200, the mobile terminal 200 maintains the screen-locked state to prevent the other user from unlocking the mobile terminal 200.

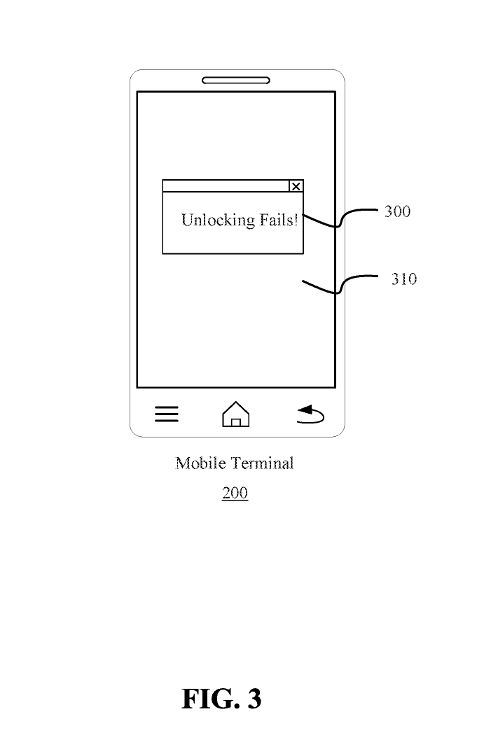

For example, when a user A is in a sleep state and a user B attempts to unlock a handset (an example of the mobile terminal 200) of user A, the handset of user A maintains a screen-locked state, because the state information of the user A is the sleep state, even if the handset of the user A detects that unlocking information input by the user B matches the preset reference unlocking information. In this way, the user B is prevented from unlocking the handset of user A, thereby improving information security for user A. In some embodiments, the mobile terminal 200 further displays a prompt message 300 indicating unlocking failure on a display 310, as shown in FIG. 3.

In some embodiments, an application (or “APP”) used by the user may be controlled according to different states of the user by performing a process described as follows. The mobile terminal 200 determines an application corresponding to the acquired state information of the user based on pre-stored correspondences between state information of the user and applications, and sets the determined application to a disabled state.

In some embodiments, the mobile terminal 200 pre-stores correspondences between state information of the user and applications. When acquiring the state information of the target user sent by the target wearable device 210, the mobile terminal 200 searches the correspondences for an application corresponding to the state information of the target user, and then sets the application found in the search to a disabled state.

For example, the state information of a user may indicate at least one of a sleep state, a running state, a walking state, and a normal state. The sleep state corresponds to all applications currently installed on the mobile terminal 200. Thus, when the target user is in a sleep state, no application in the mobile terminal 200 can be used. The running state corresponds to all game applications. Thus, when the target user is in a running state, applications other than game applications, such as phone call and music applications, can still be used. In some embodiments, no application is disabled for the normal state and the running state, so that all applications can be used in these states. The correspondences may be set by the target user.

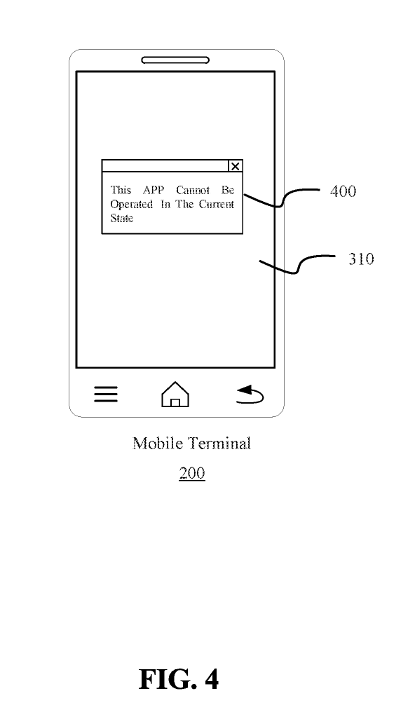

After unlocking the mobile terminal 200 successfully, the target user may click an icon displayed on the mobile terminal 200 that corresponds to an application to be used. Accordingly, the mobile terminal 200 receives a selection instruction corresponding to the application, and determines whether the application is in a disabled state. When the application is not in the disabled state, the mobile terminal 200 launches the application. When the application is in the disabled state, the mobile terminal 200 does not launch the application. Instead, the mobile terminal 200 displays a preset prompt message 400, such as “This APP Cannot Be Operated in the Current State,” as shown in FIG. 4.

Optionally, the mobile terminal 200 may record an unlocking failure event if it determines that the state information of the user satisfies the preset state condition.

In some embodiments, when the mobile terminal 200 determines that the detected unlocking information matches the preset reference unlocking information, it also determines whether the acquired state information of the target user satisfies the preset state condition. When the mobile terminal 200 determines that the state information of the user satisfies the preset state condition, the mobile terminal 200 maintains a screen-locked state, and optionally records an unlocking failure event. The mobile terminal 200 acquires current time information and stores the current time information and an unlocking failure identification in correspondence with each other. In some embodiments, when the mobile terminal 200 determines that the state information of the user satisfies the preset state condition, it further actuates a photographing component to capture image data. The photographing component of the mobile terminal 200 captures a picture or a video having a preset duration, and then stores the captured image data of the picture or video, the acquired time information, and the unlocking failure identification in correspondence with one another as an unlocking failure record. When the target user clicks an option on the mobile terminal 200 that corresponds to the unlocking failure record, the mobile terminal 200 displays the stored unlocking failure record. In this way, the target user can know a history of unlocking of the mobile terminal 200 by viewing the unlocking failure record.

Optionally, a screen of the mobile terminal 200 may be locked according to the state of the target user by performing a process described as follows. The mobile terminal 200 detects a current state of the screen, and locks the screen when the state information of the user satisfies the preset state condition and the screen is currently in an unlocked state.

In some embodiments, the mobile terminal 200 detects the current state of the screen in real time. When receiving the state information of the target user sent by the target wearable device 210, the mobile terminal 200 determines whether the state information of the target user satisfies the preset state condition. If the mobile terminal 200 determines that the state information of the target user satisfies the preset state condition, the mobile terminal 200 determines whether the current state of the screen is an unlocked state. When the current state of the screen is the unlocked state, the mobile terminal 200 locks the screen. When the current state of the screen is a locked state, the mobile terminal 200 maintains the screen-locked state. For example, when detecting that state information of a target user indicates that the target user is in a sleep state, a smart band (an embodiment of the target wearable device 210) may send the state information of the target user to the mobile terminal 200. After receiving the state information of the target user, the mobile terminal 200 determines whether the current state of the screen of the mobile terminal 200 is an unlocked state. If it is an unlocked state, the mobile terminal 200 locks the screen. In this way, when the target user is in a sleep state, the mobile terminal 200 locks its screen automatically, thereby improving information security for the target user.

In the embodiments of the present disclosure, an input of unlocking information is detected. The detected unlocking information is compared with preset reference unlocking information. State information of a user sent by a target wearable device 210 worn by the user is acquired when the detected unlocking information matches the preset reference unlocking information. Unlocking is performed when the state information of the user does not satisfy a preset state condition, and a screen-locked state is maintained when the state information of the user satisfies the preset state condition. In this way, when the state information of the user satisfies the preset state condition (for example, when the user is in a sleep state), unlocking is not performed even if the detected unlocking information matches the preset reference unlocking information, thereby improving information security for the user.

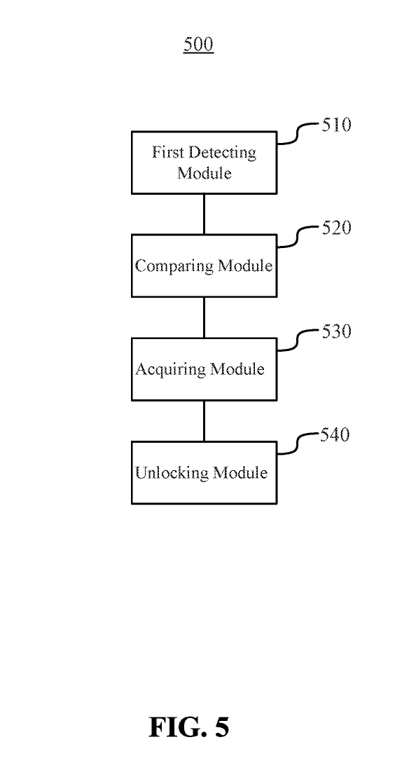

Based on the same technical concept, an embodiment of the present disclosure also provides an unlocking apparatus. FIG. 5 shows an exemplary unlocking apparatus 500. As shown in FIG. 5, the apparatus 500 includes: a first detecting module 510, a comparing module 520, an acquiring module 530, and an unlocking module 540.

The first detecting module 510 is configured to detect an input of unlocking information. The comparing module 520 is configured to compare the detected unlocking information with preset reference unlocking information. The acquiring module 530 is configured to acquire state information of a user sent by a target wearable device 210 worn by the user when the detected unlocking information matches the preset reference unlocking information. The unlocking module 540 is configured to perform unlocking when the state information of the user does not satisfy a preset state condition and to maintain a screen-locked state when the state information of the user satisfies the preset state condition.

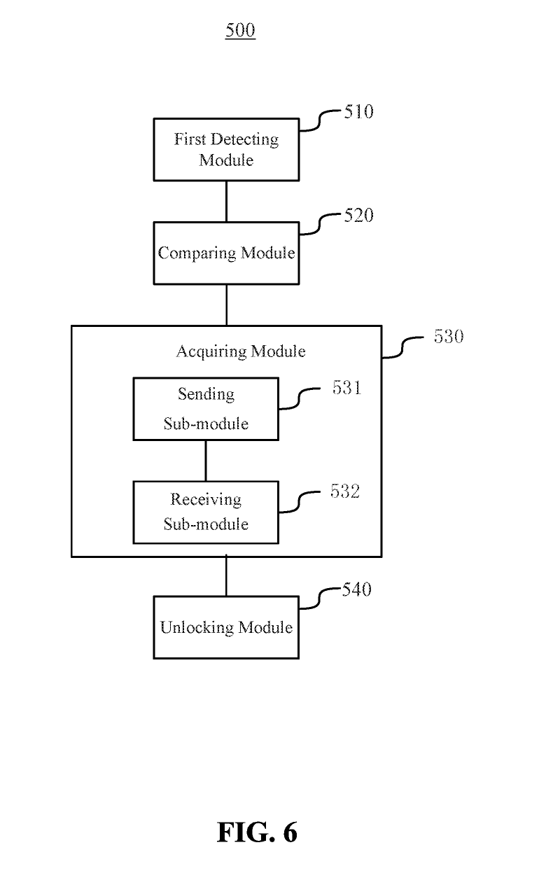

Optionally, as shown in FIG. 6, the acquiring module 530 includes a sending sub-module 531 configured to send a state information request to the target wearable device 210 worn by the user to cause the target wearable device 210 to detect the current state information of the user and a receiving sub-module 532 configured to receive the current state information of the target user sent by the target wearable device 210.

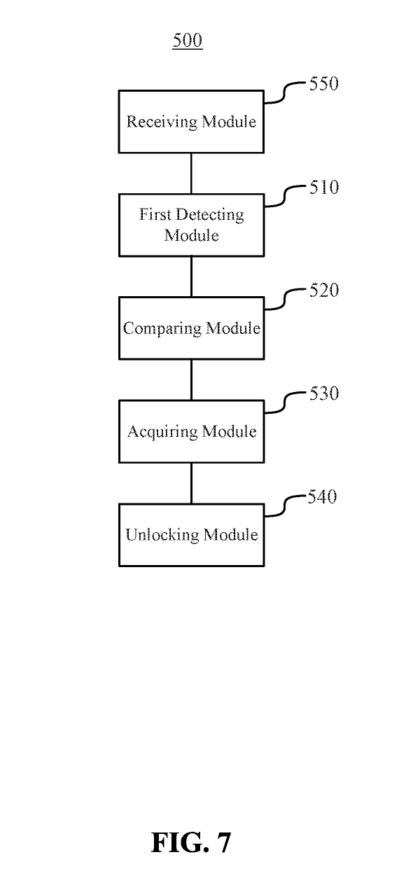

Optionally, as shown in FIG. 7, the apparatus 500 further includes a receiving module 550 configured to receive the state information of the user sent by the target wearable device 210 worn by the user and store the received state information of the user.

The acquiring module 530 is configured to acquire the stored state information of the user.

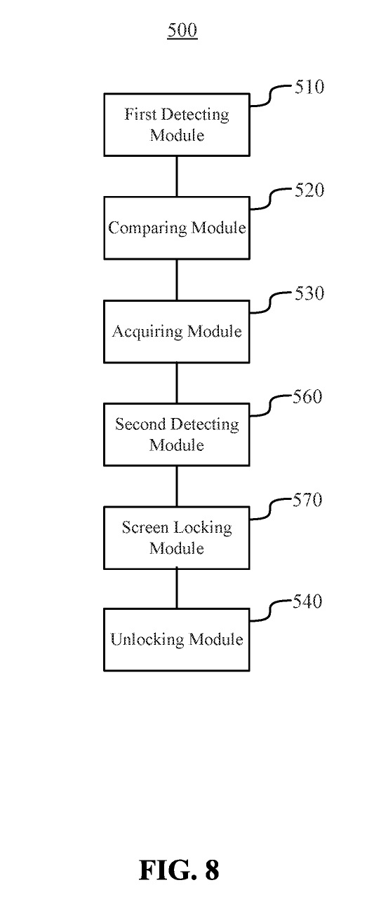

Optionally, as shown in FIG. 8, the apparatus 500 further includes a second detecting module 560 configured to detect a current state of a screen, and a screen locking module 570 configured to lock the screen when the state information of the user satisfies the preset state condition and the current state of the screen is an unlocked state.

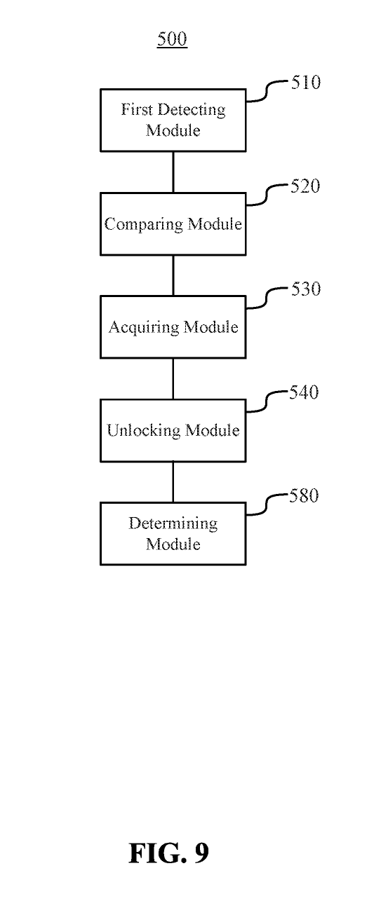

Optionally, as shown in FIG. 9, the apparatus 500 further includes a determining module 580 configured to determine an application corresponding to the acquired state information of the user based on pre-stored correspondences between state information of the user and applications, and to set the determined application to a disabled state.

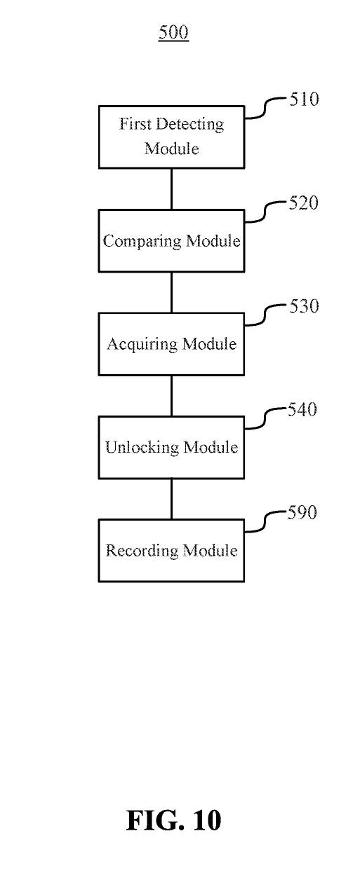

Optionally, as shown in FIG. 10, the apparatus 500 further includes a recording module 590 configured to record an unlocking failure event when the detected unlocking information matches the preset reference unlocking information and the state information of the user satisfies the preset state condition.

In the embodiments of the present disclosure, an input of unlocking information is detected. The detected unlocking information is compared with preset reference unlocking information. State information of a user sent by a target wearable device 210 worn by the user is acquired when the detected unlocking information matches the preset reference unlocking information. Unlocking is performed when the state information of the user does not satisfy a preset state condition, and a screen-locked state is maintained when the state information of the user satisfies the preset state condition. In this way, when the state information of the user satisfies the preset state condition (for example, when the user is in a sleep state), unlocking is not performed even if the detected unlocking information matches the preset reference unlocking information, thereby improving information security for the user.

It should be noted that the above-described various functional modules are only for exemplary illustration of the functions performed by the unlocking apparatus. In some embodiments, the various functions of the unlocking apparatus may be implemented by a combination of different functional modules. That is, the internal structure of the apparatus may be divided into different functional modules to realize all or part of the above-described functions. Further, since the unlocking apparatus and the unlocking methods provided in the above embodiments belong to the same concept, descriptions of the method can be applied to the descriptions of the unlocking apparatus.

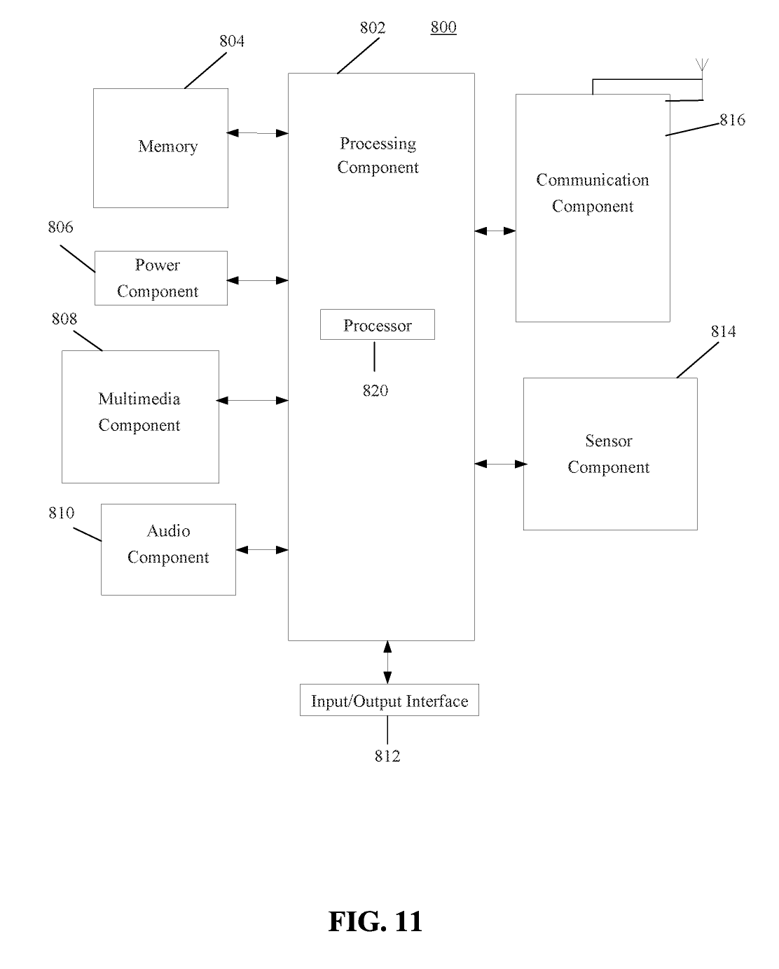

Another embodiment of the present disclosure provides a terminal 800. FIG. 11 shows a schematic structural diagram of the terminal 800. The terminal 800 may be an embodiment of mobile terminal 200 and/or target wearable device 210. The terminal 800 includes one or more of the following components: a processing component 802, a memory 804, a power component 806, a multimedia component 808, an audio component 810, an input/output (I/O) interface 812, a sensor component 814, and a communication component 816.

The processing component 802 is configured to control overall operations of the terminal 800, such as the operations associated with display, phone calls, and data communications, camera operations, and recording operations. The processing component 802 includes one or more processors 820 configured to execute instructions to perform all or part of the disclosed methods. Moreover, the processing component 802 includes one or more modules configured to facilitate the interaction between the processing component 802 and other components. For example, the processing component 802 may include a multimedia module configured to facilitate the interaction between the multimedia component 808 and the processing component 802.

The memory 804 is configured to store various types of data to support operations of the terminal 800. Examples of such data include instructions for any applications or methods run or implemented by the terminal 800, various types of data, messages, pictures, video, etc. The memory 804 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk.

The power component 806 is configured to provide power to various components of the terminal 800. The power component 806 includes a power supply management system, one or more power sources, and any other components associated with the generation, management, and distribution of power in the terminal 800.

The multimedia component 808 includes a screen providing an output interface between the terminal 800 and the user. In some embodiments, the screen includes a liquid crystal display and a touch panel. If the screen includes the touch panel, the screen may be implemented as a touch screen to receive input signals from the user. The touch panel includes one or more touch sensors configured to sense touches, swipes, and gestures on the touch panel. The touch sensors sense not only a boundary of a touch or swipe action, but also a period of time and a pressure associated with the touch or swipe action. In some embodiments, the multimedia component 808 includes a front camera and/or a rear camera. The front camera and the rear camera receive an external multimedia datum while the terminal 800 is in an operation mode, such as a photographing mode or a video mode. Each of the front camera and the rear camera has a fixed optical lens system or has focus and optical zoom capability.

The audio component 810 is configured to output and/or input audio signals. For example, the audio component 810 includes a microphone configured to receive an external audio signal when the terminal 800 is in an operation mode, such as a call mode, a recording mode, and a voice recognition mode. The received audio signal is further stored in the memory 804 or transmitted via the communication component 816. In some embodiments, the audio component 810 further includes a speaker configured to output audio signals.

The I/O interface 812 provides an interface between the processing component 802 and peripheral interface modules, such as a keyboard, a click wheel, buttons, and the like. The buttons include, but are not limited to, a home button, a volume button, a starting button, and a locking button.

The sensor component 814 includes one or more sensors configured to provide status assessments of various aspects of the terminal 800. For example, in some embodiments, the sensor component 814 detects an open/closed status of the terminal 800, relative positioning of components, e.g., the display and the keypad, of the terminal 800, a change in position of the terminal 800 or a component of the terminal 800, presence or absence of a user's contact with the terminal 800, an orientation or an acceleration/deceleration of the terminal 800, and a change in temperature of the terminal 800. The sensor component 814 includes a proximity sensor configured to detect the presence of nearby objects without any physical contact. In some embodiments, the sensor component 814 also includes a light sensor, such as a CMOS or CCD image sensor, for use in imaging applications. In some embodiments, the sensor component 814 also includes an accelerometer sensor, a gyroscope sensor, a magnetic sensor, a pressure sensor, or a temperature sensor.

The communication component 816 is configured to facilitate wired or wireless communication between the terminal 800 and other devices. The terminal 800 accesses a wireless network based on a communication standard, such as WiFi, 2G, 3G, 4G, or a combination thereof. In one embodiment, the communication component 816 receives a broadcast signal or broadcast associated information from an external broadcast management system via a broadcast channel. In some embodiments, the communication component 816 further includes a near field communication (NFC) module configured to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the terminal 800 is implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above methods.

In some embodiments, there is also provided a non-transitory computer-readable storage medium (e.g., included in memory 804) that stores instructions executable by the processor 820 in the terminal 800, for performing the disclosed methods. For example, the non-transitory computer-readable storage medium may be a ROM, a RAM, a CD-ROM, a magnetic tape, a floppy disc, an optical data storage device, and the like.

The non-transitory computer-readable storage medium has instructions stored therein that, when executed by a processor of a terminal, cause the terminal 800 to perform the disclosed method. The method includes detecting an input of unlocking information, comparing the detected unlocking information with preset reference unlocking information, and acquiring state information of a user sent by a target wearable device 210 worn by the user when the detected unlocking information matches the preset reference unlocking information. The method also includes performing unlocking when the state information of the user does not satisfy a preset state condition, and maintaining a screen-locked state when the state information of the user satisfies the preset state condition.

Optionally, acquiring the state information of the user sent by the target wearable device 210 worn by the user includes sending a state information request to the target wearable device 210 worn by the user to cause the target wearable device 210 to detect current state information of the user, and receiving the current state information of the user sent by the target wearable device 210.

Optionally, before detecting the input of the unlocking information, the method further includes receiving the state information of the user sent by the target wearable device 210 worn by the user, and storing the received state information of the user. In some embodiments, acquiring the state information of the user sent by the target wearable device 210 worn by the user includes acquiring the stored state information of the user.

Optionally, after receiving the state information of the user sent by the target wearable device 210 worn by the user and storing the state information of the user, the method further includes detecting a current state of a screen, and when the state information of the user satisfies the preset state condition and the current state of the screen is an unlocked state, locking the screen.

Optionally, the method further includes determining an application corresponding to the acquired state information of the user based on pre-stored correspondences between state information of the user and applications, and setting the determined application to a disabled state.

Optionally, the method further includes, when the detected unlocking information matches the preset reference unlocking information and the state information of the user satisfies the preset state condition, recording an unlocking failure event.

In the embodiments of the present disclosure, an input of the unlocking information is detected. The detected unlocking information is compared with preset reference unlocking information. State information of a user sent by a target wearable device 210 worn by the user is acquired when the detected unlocking information matches the preset reference unlocking information. Unlocking is performed when the state information of the user does not satisfy a preset state condition, and a screen-locked state is maintained when the state information of the user satisfies the preset state condition. In this way, when the state information of the user satisfies the preset state condition (for example, when the user is in a sleep state), unlocking is not performed even if the detected unlocking information matches the preset reference unlocking information, thereby improving information security for the user.

It should be understood by those skilled in the art that all or part of the methods may be implemented through hardware and/or through programs that provide instructions to related hardware. The programs may be stored in a computer-readable storage medium which may be a read-only memory, a magnetic disk, an optical disk, or the like.

The foregoing descriptions are only preferred embodiments of the disclosure, and are not intended to limit the disclosure. Any variation, equivalent substitution and modification that fall within the spirit and principle of the present disclosure should be embraced by the protective scope of the present disclosure.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. An unlocking method, comprising:
detecting an input of unlocking information;
comparing the detected unlocking information with preset reference unlocking information;
acquiring state information of a user sent by a target wearable device worn by the user, when the detected unlocking information matches the preset reference unlocking information; and
performing unlocking when the state information of the user does not satisfy a preset state condition, and maintaining a screen-locked state when the state information of the user satisfies the preset state condition.

2. The method according to claim 1, wherein acquiring the state information of the user sent by the target wearable device worn by the user includes:
sending a state information request to the target wearable device worn by the user to cause the target wearable device to detect current state information of the user; and
receiving the current state information of the user sent by the target wearable device.

3. The method according to claim 1, wherein before detecting the input of the unlocking information, the method further includes:
receiving the state information of the user sent by the target wearable device worn by the user, and storing the received state information of the user, and
wherein acquiring the state information of the user sent by the target wearable device worn by the user includes acquiring the stored state information of the user.

4. The method according to claim 3, wherein, after receiving the state information of the user sent by the target wearable device worn by the user and storing the received state information of the user, the method further includes:
detecting a current state of a screen; and
if the state information of the user satisfies the preset state condition and the current state of the screen is an unlocked state, locking the screen.

5. The method according to claim 1, further including:
determining an application corresponding to the state information of the user based on pre-stored correspondences between state information of the user and applications; and
setting the determined application to a disabled state.

6. The method according to claim 1, further including:
when the detected unlocking information matches the preset reference unlocking information and the state information of the user satisfies the preset state condition, recording an unlocking failure event.

7. An unlocking apparatus, comprising:
a processor; and
a memory configured to store instructions executable by the processor,
wherein the processor is configured to:
detect an input of unlocking information;
compare the detected unlocking information with preset reference unlocking information;
when the detected unlocking information matches the preset reference unlocking information, acquire state information of a user sent by a target wearable device worn by the user; and
perform unlocking when the state information of the user does not satisfy a preset state condition, and maintain a screen-locked state when the state information of the user satisfies the preset state condition.

8. The unlocking apparatus of claim 7, wherein acquiring the state information of the user sent by the target wearable device worn by the user includes:
sending a state information request to the target wearable device worn by the user to cause the target wearable device to detect current state information of the user; and
receiving the current state information of the user sent by the target wearable device.

9. The unlocking apparatus of claim 7, wherein the processor is also configured to:
before detecting the input of the unlocking information, receive the state information of the user sent by the target wearable device worn by the user, and store the received state information of the use, and
wherein acquiring the state information of the user sent by the target wearable device worn by the user includes acquiring the stored state information of the user.

10. The unlocking apparatus of claim 9, wherein the processor is also configured to:
after receiving the state information of the user sent by the target wearable device worn by the user and storing the received state information of the user,
detect a current state of a screen; and
when the state information of the user satisfies the preset state condition and the current state of the screen is an unlocked state, lock the screen.

11. The unlocking apparatus of claim 7, wherein the processor is further configured to:
determine an application corresponding to the acquired state information of the user based on pre-stored correspondences between the state information of the user and applications; and
set the determined application to a disabled state.

12. The unlocking apparatus of claim 7, wherein the processor is further configured to:
when the detected unlocking information matches the preset reference unlocking information and the state information of the user satisfies the preset state condition, record an unlocking failure event.

13. A non-transitory computer-readable storage medium having instructions stored therein that, when executed by a processor of a mobile terminal, cause the mobile terminal to perform an unlocking method, the method comprising:
detecting an input of unlocking information;
comparing the detected unlocking information with preset reference unlocking information;
acquiring state information of a user sent by a target wearable device worn by the user when the detected unlocking information matches the preset reference unlocking information; and
performing unlocking when the state information of the user does not satisfy a preset state condition, and maintaining a screen-locked state when the state information of the user satisfies the preset state condition.

14. The storage medium of claim 13, wherein acquiring the state information of the user sent by the target wearable device worn by the user includes:
sending a state information request to the target wearable device worn by the user to cause the target wearable device to detect current state information of the user; and
receiving the current state information of the user sent by the target wearable device.

15. The storage medium of claim 13, wherein the method further includes:
before detecting the input unlocking information, receiving the state information of the user sent by the target wearable device worn by the user, and storing the received state information of the user, and
wherein acquiring the state information of the user sent by the target wearable device worn by the user includes acquiring the stored state information of the user.

16. The storage medium of claim 15, wherein the method further includes:
after receiving the state information of the user sent by the target wearable device worn by the user and storing the received state information of the user,
detecting a current state of a screen; and
when the state information of the user satisfies the preset state condition and the current state of the screen is an unlocked state, locking the screen.

17. The storage medium of claim 13, wherein the method further includes:
determining an application corresponding to the state information of the user based on pre-stored correspondences between state information of the user and applications; and
setting the determined application to a disabled state.

18. The storage medium of claim 13, wherein the method further includes:
when the detected unlocking information matches the preset reference unlocking information and the state information of the user satisfies the preset state condition, recording an unlocking failure event.
